(19) United States
(12) Patent Application Publication
(10) Pub. No.: US 2003/0160975 A1
(43) Pub. Date: Aug. 28, 2003

(54) N-up printing methods and systems

(76) Inventors: Vincent C. Skurdal, Boise, ID (US); Mark L. Brown, Boise, ID (US); Marvin D. Nelson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/087,419

(22) Filed: Feb. 26, 2002

(51) Int. Cl. G06K 15/02; H04N 1/387

(52) U.S. Cl. 358/1.2; 358/1.18; 358/1.11; 358/450

(57) ABSTRACT

Methods and systems can automatically select an N-Up printing mode that is tailored to ensure that a printed document contains information that is desirably decipherable by a user. Where a document contains text, the inventive methods and systems can ensure that all text on the document is readable. Where a document contains graphics, the methods and systems can ensure that the graphics are printed at a desired level of resolution.

### TECHNICAL FIELD

This invention relates to methods and systems for printing documents and, in particular, to N-up printing methods and systems.

### BACKGROUND

An important aspect of a modern computer is the ability to create, visually display, store and print documents containing textual and/or graphical information. In order to print a document, some sort of printing device under the control of the computer is used to generate a permanent image of the document on a designated print medium.

To print a document that is, for example, stored in the random access memory (RAM) of the computer, several actions typically take place. First, since the designated print medium generally has a fixed size, the printable information contained in the document may need to be divided into sections suitable to fit onto the print medium through a process called pagination.

Pagination is generally performed by a computer under the direction of one or more software programs. In addition, pagination is accomplished with information regarding various dimensional parameters that pertain both to the document and to the selected print medium. As a result of pagination, the document is divided into sections suitable to fit onto the selected print medium. For purposes of this discussion, these sections are referred to herein as “logical pages”.

After the logical pages are created, they may then be transmitted to the printer in the form of a print job for printing. In addition to containing logical pages, the print job may also include various printer control commands. One type of printer control command directs the printer to perform “N-UP printing”. The letter “N” represents the number of logical pages that are to be scaled (if necessary) and printed onto a single designated print medium. For purposes of this discussion, a logical page that has been scaled for N-UP printing is referred to herein as a “sub-page”.

Consider, for example, FIG. 1. There, a document that is to be printed is shown generally at 100 and comprises logical pages 102, 104, 106, and 108. Now, assume that the user has selected a print option to print document 100 using the 4-Up option. What this means is that the printed document will now contain, on a single page, each of the four logical pages 102-108. Of course, the logical pages will be scaled appropriately so that they will fit adequately on a single page. Specifically, consider document 110 which represents the printed document that has been printed using 4-up printing. There, each of the logical pages 102-108 is represented by a printed portion of document 110 that corresponds to the scaled sub-page that represents its associated logical page. For example, the sub-page that is associated with logical page 102 now appears as printed portion 102a. Likewise, there is a one-to-one correspondence between each of logical pages 104, 106, and 108 and their corresponding printed portions 104a, 106a, and 108a respectively.

The nice thing about N-Up printing is that it enables a user to proof a document before each page is individually printed. Thus, a user is able to view the layout of each page in relation to other pages that are printed on the same side of a print medium. One problem with N-Up printing, however, is that in the process of scaling logical pages to provide their associated sub-pages, the text or graphics that appear on the ultimately printed print medium may be too small to be visually discerned with any degree of certainty. For example, consider a page that has a number of footnotes printed in a small font. If this page were printed using 4-Up printing, the footnotes would likely be to small for a reader to read. This can be undesirable, especially when a reader desires to read the footnotes. As a result, the reader may then have to reprint the document using perhaps 2-Up printing so that the footnotes are readable. This has not only inconvenienced the reader, but has wasted paper as well.

As a specific example, consider the graphics that appear at the lower right hand corner of logical page 102. If the graphics contain images or data that is desired to be visually discerned by a reader, then when the document is scaled and printed in the 4-Up mode, the corresponding printed portion 102a may contain a graphics portion that is simply too small to be of any use to the reader.

Consider additionally this example. Assume that a user has a document with a single letter on each page that is to be printed in a very large font. Assume also that the user desires, for purposes of proofing the document, to print the document in an N-Up mode. For the user's purposes, they really only need to be barely able to make out the letter that is to appear on each page. Assume now the user selects 4-Up printing and prints the document. There is no doubt that the user will be able to adequately make out each letter on each page. For their purposes, however, the user may have unnecessarily used or wasted paper if, for example, each letter appearing on a page could have been adequately read by the user at—say—25-Up mode.

Accordingly, this invention arose out of concerns associated with providing improved N-Up printing systems and methods.

### SUMMARY

Methods and systems for printing documents are described. In one embodiment, data defining a document that is to be printed on a printer is received and processed to identify one or more characteristics of the data. Based on the characteristics, an N-Up printing mode in which to print the document is automatically selected. In one embodiment, at least one of the characteristics pertains to a font that is to appear on a printed document.

In another embodiment, an apparatus comprises memory, one or more processors, and computer-readable instructions in the memory which, when executed by the one or more processors, cause the processors to receive data defining a document that is to be printed on a printer; process the data to identify one or more characteristics of the data; and based on the one or more characteristics, select an N-Up printing mode in which to print the document.

In yet another embodiment, a software architecture comprises an N-Up analysis module configured to receive data defining a document that is to be printed on a printer; process the data to identify one or more characteristics of the data; and based on the one or more characteristics, select an N-Up printing mode in which to print the document. The module comprises a text analyzer configured to process data associated with text, and a graphics analyzer configured to process data associated with graphics.

### BRIEF DESCRIPTION OF THE DRAWINGS

The same numbers are used throughout the drawings to reference like features and components.

FIG. 1 is a diagram that illustrates aspects of N-Up printing.

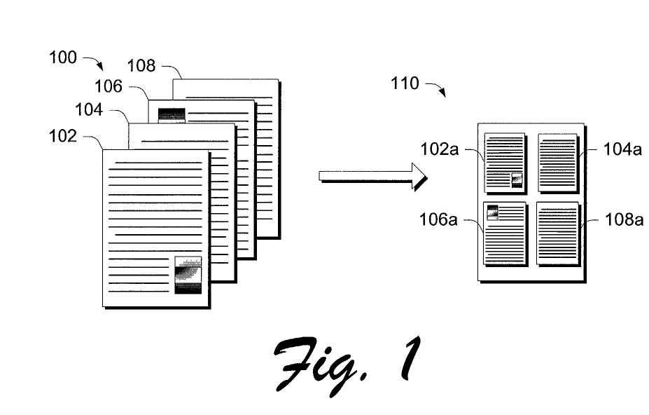

FIG. 2 is an illustration of an exemplary network in which various inventive techniques and systems can be employed.

FIG. 3 is a block diagram that illustrates various components of an exemplary printer that can be utilized to implement one or more inventive embodiments.

FIG. 4 is a block diagram that illustrates various components of an exemplary work station that can be used to implement one or more inventive embodiments.

FIG. 5 is a block diagram that illustrates an exemplary N-Up analysis module in accordance with one embodiment.

FIG. 6 is a block diagram of an exemplary look up table in accordance with one embodiment.

FIG. 7 is a flow diagram that describes steps in a method in accordance with one embodiment.

### DETAILED DESCRIPTION

Overview

The methods and systems described below can automatically select an N-Up printing mode that is tailored to ensure that a printed document contains information that is desirably decipherable by a user. Where a document contains text, the inventive methods and systems can ensure that all text on the document is readable. Where a document contains graphics, the methods and systems can ensure that the graphics are printed at a desired level of resolution. This can not only advantageously save paper and conserve printer resources, but can enhance a user's experience as well.

Exemplary Network Environment

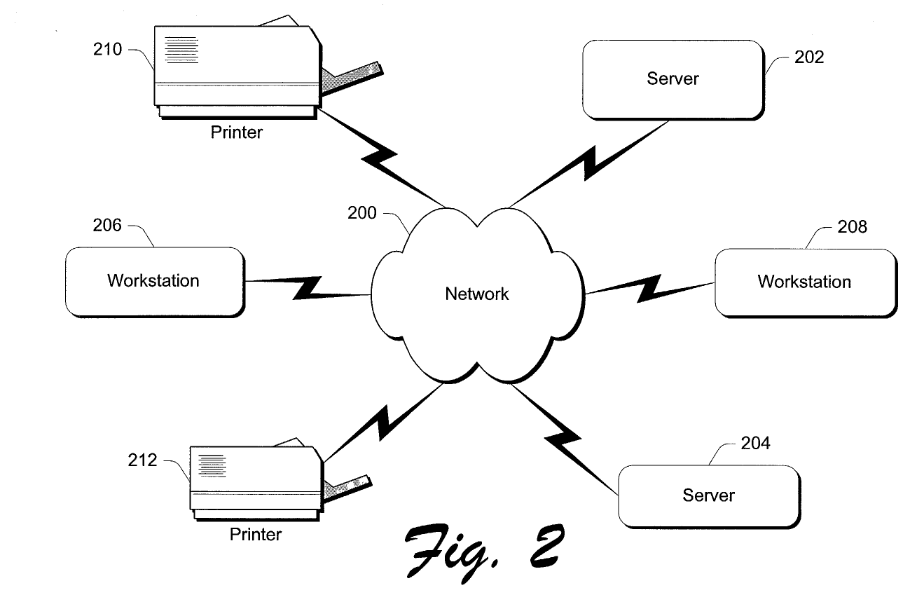

FIG. 2 illustrates a network environment in which the inventive techniques and structures described herein can be employed. The network environment can comprise multiple servers, workstations, and printers that are coupled to one another via a data communication network 200. The network 200 couples together servers 202 and 204, computer workstations 206 and 208, and printers 210 and 212. Network 200 can be any type of network, such as a local area network (LAN) or a wide area network (WAN), using any type of network topology and any network communication protocol. Although only a few devices are shown coupled to network 200, a typical network may have tens or hundreds of devices coupled to one another. Furthermore, network 200 may be coupled to one or more other networks, thereby providing coupling between a greater number of devices. Such can be the case, for example, when networks are coupled together via the Internet.

Servers 202 and 204 may be file servers, email servers, database servers, or any other type of network server. Workstations 206 and 208 can be any type of computing device, such as a personal computer. In particular embodiments, printers 210 and 212 can be laser printers. However, alternate embodiments can be implemented in connection with ink-jet or any other type of printer.

Exemplary Printer Architecture

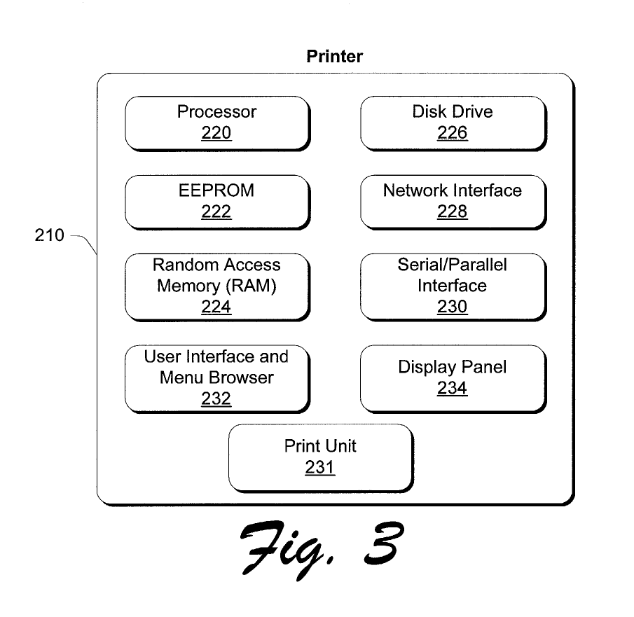

FIG. 3 is a block diagram showing exemplary components of printer 210 in accordance with one embodiment. Printer 210 includes a processor 220, an electrically erasable programmable read-only memory (EEPROM) 222, and a random access memory (RAM) 224. Processor 220 processes various instructions necessary to operate the printer 210 and communicate with other devices. EEPROM 222 and RAM 224 store various information such as configuration information, fonts, templates, data being printed, and menu structure information. Although not shown in FIG. 3, a particular printer may also contain a ROM (non-erasable) in place of or in addition to EEPROM 222. Furthermore, a printer may alternatively contain a flash memory device in place of or in addition to EEPROM 222.

Printer 210 also includes a disk drive 226, a network interface 228, and a serial/parallel interface 230. Disk drive 226 provides additional storage for data being printed or other information used by the printer 210. Although both RAM 224 and disk drive 226 are illustrated in FIG. 3, a particular printer may contain either RAM 224 or disk drive 218, depending on the storage needs of the printer. For example, an inexpensive printer may contain a small amount of RAM 224 and no disk drive 218, thereby reducing the manufacturing cost of the printer. Network interface 228 provides a connection between printer 210 and a data communication network, such as network 200. Network interface 228 allows devices coupled to a common data communication network to send print jobs, menu data, and other information to printer 210 via the network. Similarly, serial/parallel interface 230 provides a data communication path directly between printer 210 and another device, such as a workstation, server, or other computing device. Although the printer 210 shown in FIG. 3 has two interfaces (network interface 228 and serial/parallel interface 230), a particular printer may only contain one interface.

Printer 210 also includes a print unit 231 that includes mechanisms that are arranged to selectively apply ink (e.g., liquid ink, toner, etc.) to a print media (e.g., paper, plastic, fabric, etc.) in accordance with print data within a print job. Thus, for example, print unit 231 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 231 can also be configured to support duplex printing, for example, by selectively flipping or turning the print media as required to print on both sides. Those skilled in the art will recognize that there are many different types of print units available, and that for the purposes of the present invention print unit 231 can include any of these various types.

Printer 210 also contains a user interface/menu browser 232 and a display panel 234. User interface/menu browser 232 allows the user of the printer to navigate the printer's menu structure. User interface 232 may be a series of buttons, switches or other indicators that are manipulated by the user of the printer. Display panel 234 is a graphical display that provides information regarding the status of the printer and the current options available through the menu structure.

The illustrated printer can, and typically does include software that provides a runtime environment in which software applications or applets can run or execute. The runtime environment can facilitate the extensibility of the printer by allowing various interfaces to be defined that, in turn, allow applications or applets to interact with the printer in more robust manners.

Exemplary WorkStation Architecture

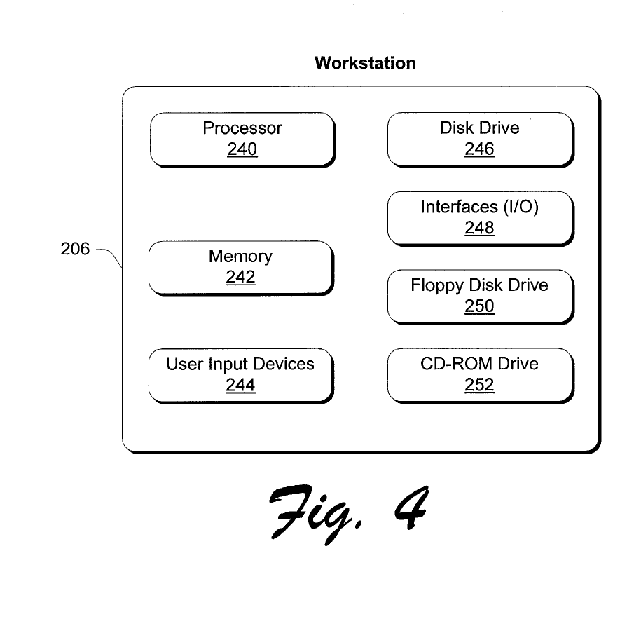

FIG. 4 is a block diagram showing exemplary components of a computer workstation 206. Workstation 206 includes a processor 240, a memory 242 (such as ROM and RAM), user input devices 244, a disk drive 246, interfaces 248 for inputting and outputting data, a floppy disk drive 250, and a CD-ROM drive 252. Processor 240 performs various instructions to control the operation of workstation 206. Memory 242, disk drive 246, and floppy disk drive 250, and CD-ROM drive 252 provide data storage mechanisms. User input devices 244 include a keyboard, mouse, pointing device, or other mechanism for inputting information to workstation 206. Interfaces 248 provide a mechanism for workstation 206 to communicate with other devices.

Exemplary N-UP Analysis Module

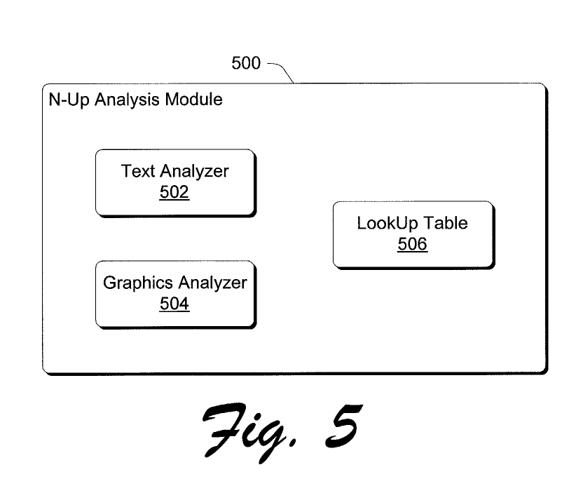

FIG. 5 shows an exemplary N-Up analysis module 500 in accordance with one embodiment.

Module 500 can be implemented in accordance with any suitable hardware, software, firmware, or combination thereof. In the illustrated example, module 500 is implemented in software. Module 500 functions to process data that is associated with a document that is to be printed, and then automatically select an N-Up mode that is most desirable given various characteristics that are associated with the data.

Module 500 can reside at any suitable location associated with document printing. For example, module 500 can comprise part of a printer or printing device on which printing is to take place. Alternately or additionally, module 500 can comprise part of the software that resides on a user's computer such as a personal computer or work station like the one described above. In this example, the module can comprise part of a print driver that processes print jobs that are to be printed. Module 500 can also comprise part of a print server that is part of a network where the print server receives print jobs from multiple different clients and routes the print jobs to the appropriate printer on the network. Further, the module 500 can comprise part of an application that provides data that it to be printed. For example, a word processing application can include an N-Up analysis module 500 that processes data that is to be printed as described below. Further, such applications can include various types of graphics applications that enable a user to create documents that contain graphics. Examples of these types of applications can include CAD applications and the like.

Needless to say, there are simply numerous places where a suitably configured N-Up analysis module can reside. In this specific example, the N-Up analysis module 500 comprises a text analyzer 502, a graphics analyzer 504, and one or more look-up tables 506.

Text analyzer 502 functions to process data that is associated with a document that is to be printed. The text analyzer receives such data and can process the data to identify characteristics of the data. These characteristics affect the N-Up mode that is selected for printing. For example, the text analyzer can process the data to identify a characteristic that pertains to the smallest font that would be printed if the document were to be printed in 1-Up mode (i.e. one logical page for each printed page). Based on the smallest font identified by the text analyzer 502, an intelligent decision can be made with respect to the value N for use in printing in the N-Up mode. This intelligent decision can be made using any suitable techniques. One exemplary technique is to collect empirical data that associates various characteristics that can be embodied in a document that is to be printed, and a desired value for N in the N-Up printing mode. This empirical data can be embodied in look up table 506. So, for example, as the text analyzer identifies the smallest font that would be printed in a particular document, it can consult the look up table 506 to ascertain the desirable value for N.

It should be appreciated and understood that while the example above is given in the context of characteristics that pertain to the smallest font that would be printed if a document were to be printed, other characteristics can be alternately or additionally used. For example, font types (e.g. Times New Roman, Courier, Arial and the like), font complexities (e.g. fonts that are in all capital or lower case letters), graphics-based fonts (smiley faces, hearts, diamonds, clubs and the like) can all be used to ascertain a desired value for N to be used in N-Up printing.

Graphics analyzer 504 functions to process data that is associated with a document that is to be printed. The graphics analyzer receives such data, and in particular graphics data such as images (GIFs, JPEGs and the like), embedded objects, and the like, and can process the data to identify characteristics pertaining to the data that affect the N-Up mode that is selected for printing. For example, if a picture appears in the corner of a document, graphics processing techniques can be employed to determine pertinent sizes of objects that appear in the picture. Perhaps a family picture contains images of Mom, Dad and Aunt Minnie. The graphics processing techniques can identify the pertinent objects as people, and then determine, based on these objects' sizes, a desire value of N such that the ultimately rendered N-Up document will contain an image where the objects are still identifiable as people and, more particularly, Mom, Dad and Aunt Minnie.

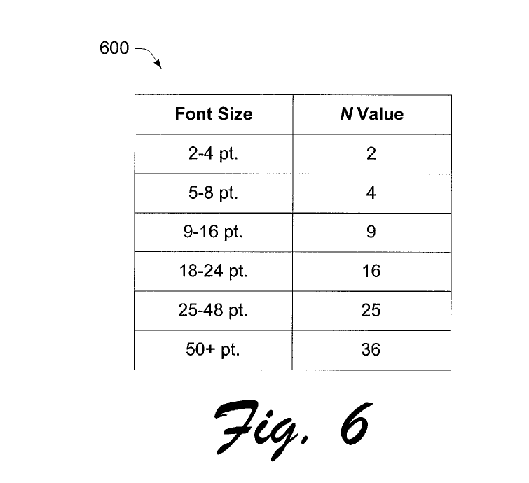

Consider, for example, FIG. 6 which shows but one exemplary look up table 600. There, the left most column is designated “Font Size” and the right most column is designated “N Value”. This table represents desired values of N for given font sizes. For example, if a document that is intended for printing is determined to contain, as a smallest font size, 3 point font, then the N-Up analysis module 500 (FIG. 5) selects N=2 and thus, the ultimately printed document would be printed in 2-Up mode. Similarly, if the N-Up analysis module analyzes a document and determines that the text that is to be printed contains only 12 point font, then the module would select N=9 and thus, the document would be printed in 9-Up mode.

By analyzing a document that is intended for printing and automatically selecting an N-Up mode that most desirably presents the document's data, not only can paper be conserved, but the user's experience can be desirably enhanced. Specifically, the user will be assured in most if not all circumstances that the text or graphics appearing on the ultimately-printed document will be readable or desirably perceptible.

Exemplary Method

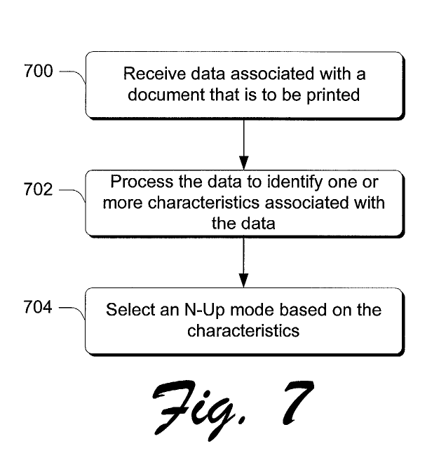

FIG. 7 is a flow diagram that described steps in a method in accordance with one embodiment. The steps can be implemented in any suitable hardware, software, firmware or combination thereof. In the illustrated example, the steps are implemented in software. FIG. 5 provides but one example of a suitable software architecture that can be utilized to implement the method about to be described. Of course, other software architectures can be used.

Step 700 receives data associated with a document that is to be printed. The data that is received can comprise any suitable type of data that is capable of representing the document that is to be printed. For example, the data can comprise data in a Page Description Language (PDL) that is configured for provision to a printer for printing. The data can also comprise a bit map that can represent the document. Such a bit map can be embodied in, for example, raster data. In addition, the act of receiving the data can be accomplished at any suitable location between (and including) the client or computing device that sends the document for printing and the printer that is to actually print the document. Step 702 processes the data to identify one or more characteristics associated with the data. Any suitable characteristic or characteristics can be utilized. For example, suitable characteristics can include, without limitation, those associated with font size, font type, font complexity, graphics-based fonts, and the like. Additionally, as noted above, characteristics associated with graphics can also be identified and used in the analysis.

Once the characteristic or characteristics have been identified, step 704 selects an N-Up mode based on the characteristic or characteristics. This step can be implemented in any suitable way. For example, a look up table can be consulted to ascertain a mapping from the identified characteristics to the desirable N-Up mode.

Learned or Adaptive Selection

In accordance with one embodiment, the N-Up selection process is adaptive and/or can learn from past experiences. For example, and with reference to FIG. 5, if the N-Up analysis module 500 selects a particular N-Up mode based on its analysis of a particular document, and the user determines that the printed document is undesirable because, for example, the text has been printed too small, the user can provide input to the N-Up analysis module to override the default settings. Assume, for example, that the particular user has trouble reading small print and that the N-Up module processes a document and prints it in a 4-Up mode. Assume also that for the majority of people, printing this particular document in the 4-Up mode is acceptable. In this case, the user can, for example, pull up a user-interface window and indicate that this particular document should be printed in a 2-Up mode. Now, at this point, the user has not done anything other than to inform the software that the software's selection of the 4-Up mode was undesirable and that the better mode was the 2-Up mode. In this case, then, the N-Up analysis module 500 can automatically update the look up table to indicate that the characteristics that it used to map to the 4-Up mode should now map to the 2-Up mode. It should be noted that this can be done on a per user basis.

As an additional extension, the N-Up analysis module can update its look up table automatically without user input. For example, assume that a user prints a particular document that is automatically printed in the 4-Up mode. The user then reprints the same document and manually selects the 2-Up mode thus overriding the automatically selected 4-Up mode. In this case, there was a reason the user opted to reprint the document in the 2-Up mode. Quite likely the reason is that there was something undesirable about the appearance of the printed document. In accordance with this embodiment, the N-Up analysis module can note that, for this particular type of document embodying the type of characteristics that it does, the better mapping for the characteristics is to the 2-Up mode rather than the 4-Up mode. Thus, the N-Up analysis module can take steps to automatically modify the mapping in its look up table, without the user having to manually pull up a window and make the adjustments. In this way, the software can automatically anticipate what a user desires in a printed document.

Conclusion

The above-described methods and systems can automatically select an N-Up printing mode that is tailored to ensure that a printed document contains information that is desirably decipherable by a user. Where a document contains text, the inventive methods and systems can ensure that all text on the document is readable. Where a document contains graphics, the methods and systems can ensure that the graphics are printed at a desired level of resolution. This can not only advantageously save paper and conserve printer resources, but can enhance a user's experience as well.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

We claim:

1. A computer-implemented method comprising:
receiving data defining a document that is to be printed on a printer;
processing the data to identify one or more characteristics of the data; and
based on the one or more characteristics, automatically selecting an N-Up printing mode in which to print the document.

2. The computer-implemented method of claim 1, wherein the act of processing the data comprises processing data associated with text.

3. The computer-implemented method of claim 1, wherein the act of processing the data comprises processing data associated with graphics.

4. The computer-implemented method of claim 1, wherein the act of processing the data comprises processing data associated with both text and graphics.

5. The computer-implemented method of claim 1, wherein the act of selecting comprises performing a mapping operation, based on the one or more characteristics, effective to map the one or more characteristics to an N-Up mode.

6. The computer-implemented method of claim 5, wherein the act of performing comprises consulting a look up table containing a plurality of characteristic values and N-Up mode values each of which being associated with one or more characteristic values.

7. The computer-implemented method of claim 1 further comprising changing one or more characteristics with which an N-Up printing mode is associated effective such that future documents that embody the changed characteristics will be printed in the associated N-Up mode.

8. The computer-implemented method of claim 7, wherein the act of changing is performed responsive to user input.

9. One or more computer-readable media having computer-readable instructions thereon which, when executed by one or more processors, cause the one or more processors to:
receive data defining a document that is to be printed on a printer;
process the data to identify one or more characteristics of the data; and
based on the one or more characteristics, automatically select an N-Up printing mode in which to print the document.

10. The one or more computer-readable media of claim 9, wherein the instructions cause the one or more processors to process data associated with text.

11. The one or more computer-readable media of claim 9, wherein the instructions cause the one or more processors to process data associated with graphics.

12. The one or more computer-readable media of claim 9, wherein the instructions cause the one or more processors to process data associated with both text and graphics.

13. The one or more computer-readable media of claim 9, wherein the instructions cause the one or more processors to select an N-Up printing mode by performing a mapping operation, based on the one or more characteristics, effective to map the one or more characteristics to an N-Up mode.

14. The one or more computer-readable media of claim 13, wherein the instructions cause the one or more processors to perform the mapping operation by consulting a look up table containing a plurality of characteristic values and N-Up mode values each of which being associated with one or more characteristic values.

15. The one or more computer-readable media of claim 9, wherein the instructions further cause the one or more processors to change one or more characteristics with which an N-Up printing mode is associated effective such that future documents that embody the changed characteristics will be printed in the associated N-Up mode.

16. The one or more computer-readable media of claim 15, wherein the instructions cause the one or more processors to change one or more characteristics responsive to user input.

17. A computer-implemented method comprising:
receiving data defining a document that is to be printed on a printer;
processing the data to identify one or more characteristics of the data, at least one of the characteristics pertaining to a font that is to appear on a printed document; and
based on the one or more characteristics, selecting an N-Up printing mode in which to print the document.

18. The computer-implemented method of claim 17, wherein said at least one characteristic pertaining to the font pertains to a font size.

19. The computer-implemented method of claim 17, wherein said at least one characteristic pertaining to the font pertains to a smallest font size that would appear on the printed document.

20. The computer-implemented method of claim 17, wherein said at least one characteristic pertaining to the font pertains to a font type.

21. The computer-implemented method of claim 17, wherein said at least one characteristic pertaining to the font pertains to a font complexity.

22. The computer-implemented method of claim 17, wherein said at least one characteristic pertaining to the font pertains to at least one graphics-based font.

23. The computer-implemented method of claim 17, wherein said act of processing the data comprises processing data associated with graphics.

24. The computer-implemented method of claim 17, wherein said act of receiving data comprises receiving page description language (PDL) data.

25. The computer-implemented method of claim 17, wherein said act of receiving data comprises receiving bit map data.

26. One or more computer-readable media having computer-readable instructions thereon which, when executed by one or more processors, cause the one or more processors to:
receive data defining a document that is to be printed on a printer;
process the data to identify one or more characteristics of the data, at least one of the characteristics pertaining to a font that is to appear on a printed document; and
based on the one or more characteristics, select an N-Up printing mode in which to print the document.

27. The one or more computer-readable media of claim 26, wherein the instructions cause the one or more processors to process the data to identify at least one characteristic pertaining to a font size.

28. The one or more computer-readable media of claim 26, wherein the instructions cause the one or more processors to process the data to identify at least one characteristic pertaining to a smallest font size that would appear on the printed document.

29. The one or more computer-readable media of claim 26, wherein the instructions cause the one or more processors to process the data to identify at least one characteristic pertaining to a font type.

30. The one or more computer-readable media of claim 26, wherein the instructions cause the one or more processors to process the data to identify at least one characteristic pertaining to a font complexity.

31. The one or more computer-readable media of claim 26, wherein the instructions cause the one or more processors to process the data to identify at least one characteristic pertaining to at least one graphics-based font.

32. The one or more computer-readable media of claim 26, wherein the instructions cause the one or more processors to process the data associated with graphics.

33. The one or more computer-readable media of claim 26, wherein the instructions cause the one or more processors to receive and process page description language (PDL) data.

34. The one or more computer-readable media of claim 26, wherein the instructions cause the one or more processors to receive and process bit map data.

35. An apparatus comprising:
memory;
one or more processors;
computer-readable instructions in the memory which, when executed by the one or more processors, cause the processors to:
receive data defining a document that is to be printed on a printer;
process the data to identify one or more characteristics of the data;
based on the one or more characteristics, select an N-Up printing mode in which to print the document.

36. The apparatus of claim 35, wherein the data that is processed is associated with text.

37. The apparatus of claim 35, wherein the data that is processed is associated with graphics.

38. The apparatus of claim 35, wherein the data that is processed is associated with both text and graphics.

39. The apparatus of claim 35, wherein the N-Up printing mode is selected by performing a mapping operation, based on the one or more characteristics, effect to map the one or more characteristics to an N-Up mode.

40. The apparatus of claim 35 embodied as a printer.

41. The apparatus of claim 35 embodied as a client computing device.

42. The apparatus of claim 35 embodied as a server.

43. A software architecture comprising:
an N-Up analysis module configured to:
receive data defining a document that is to be printed on a printer;
process the data to identify one or more characteristics of the data; and
based on the one or more characteristics, select an N-Up printing mode in which to print the document, the module comprising:
a text analyzer configured to process data associated with text, and
a graphics analyzer configured to process data associated with graphics.

44. The software architecture of claim 43 further comprising a look up table containing a plurality of characteristic values and N-Up mode values each of which being associated with one or more characteristic values.

45. The software architecture of claim 44, wherein the module is configured to select an N-Up mode by mapping one or more characteristic values to an associated N-Up mode value.

46. The software architecture of claim 43, wherein the N-Up analysis module is embodied as a print driver.

47. The software architecture of claim 43, wherein the N-Up analysis module is embodied in a printer.

48. The software architecture of claim 43, wherein the N-Up analysis module is embodied in a client computer.

49. The software architecture of claim 43, wherein the N-Up analysis module is embodied in a server.
